(19) United States
(12) Patent Application Publication
(10) Pub. No.: US 2004/0196609 A1
(43) Pub. Date: Oct. 7, 2004

(54) Protection circuit scheme for electrostatic discharge

(76) Inventor: Hung-Sui Lin, Hsin-Ying (TW)

Correspondence Address: J.C. Patents, Inc., Suite 250, 4 Venture, Irvine, CA, 92618, US

(21) Appl. No.: 10/435,583

(22) Filed: May 9, 2003

(30) Foreign Application Priority Data
Apr. 2, 2003 (TW) 92107484

(51) Int. Cl. H02H 9/00; H02H 9/06

(52) U.S. Cl. 361/119

(57) ABSTRACT

A protection circuit scheme for electrostatic discharge, the protection circuit scheme includes the electrostatic discharge clamp circuit and the isolated circuit. The electrostatic discharge clamp circuit herein receives the electrostatic voltage from the signal input, and the isolated circuit receives the high frequency signal from the signal input. At the same time, the isolated circuit also isolates the direct bias from the internal circuit to prevent the loss of the latch up of the electrostatic discharge clamp circuit.

### CROSS-REFERENCE TO RELATED APPLICATION

This application claims the priority benefit of Taiwan application serial no. 92107484, filed Apr. 2, 2003.

### BACKGROUND OF THE INVENTION

1. Field of Invention

The present invention generally relates to a protection circuit scheme, and more particularly, to a protection circuit scheme for electrostatic discharge.

2. Description of Related Art

FIG. 1 schematically shows a circuit block diagram of a conventional protection circuit scheme for electrostatic discharge. The protection circuit scheme for electrostatic discharge 120 comprises two electrostatic discharge clamp circuits 122 that are electrically coupled with each other, and the protection circuit scheme for electrostatic discharge 120 also electrically couples to a signal input 130 and an internal circuit 110. The power clamp circuit 100, the internal circuit 110, and the protection circuit scheme for electrostatic discharge 120 are all electrically coupled to a ground terminal and a voltage source. In the prior art, the electrostatic discharge clamp circuit 122 is a diode, an N-type Metal Oxide Semiconductor (MOS), or a P-type Metal Oxide Semiconductor (MOS). However, if the electrostatic discharge clamp circuit 122 is applied in the wireless circuit module, since the electrostatic discharge clamp circuit 122 does not work well under low load, the protection circuit scheme for electrostatic discharge 120 cannot protect the circuit well.

Therefore, in the prior art, in order to eliminate the defect shown in FIG. 1, a matching circuit 140 is especially added in between the protection circuit scheme for electrostatic discharge 120 and a signal input 130 as shown in FIG. 2, which schematically shows a circuit block diagram of another protection circuit scheme for electrostatic discharge. Similarly, the protection circuit scheme for electrostatic discharge 120 also comprises two electrostatic discharge clamp circuits 122 that are electrically coupled with each other, and the protection circuit scheme for electrostatic discharge 120 electrically couples to the matching circuit 140 and an internal circuit 110. The matching circuit 140 is electrically coupled to the signal input 130. The power clamp circuit 100, the internal circuit 110, and the protection circuit scheme for electrostatic discharge 120 are all electrically coupled to a ground terminal and a voltage source. In FIG. 2, even though it eliminates the defect of high load in the electrostatic discharge clamp circuit 122 in FIG. 1, since the matching circuit 140 is added extra, it causes a waste of space inside the integrated circuit and the silicon area in the integrated circuit.

Further, referring to both FIG. 1, and FIG. 2, the internal circuit 110 receives a direct bias provided by the voltage source, and there is also a direct bias leaked from the internal circuit 110, such direct bias may cause a latch up problem for the protection circuit, and may further cause the malfunction of the protection circuit. Since the internal circuit 110 is a slim gate oxide element, in order to protect the internal circuit 110, the electrostatic discharge clamp circuit 122 must have a fast trigger time and a low sustain voltage. However, when the electrostatic discharge clamp circuit 122 is working in low sustain voltage, it is easily interfered by the noise from the power or signal source, thus causing the latch up problem.

In summary, the conventional protection circuit scheme for electrostatic discharge has the following disadvantages:

(1) When the electrostatic discharge clamp circuit is working in low sustain voltage, the conventional protection circuit scheme for electrostatic discharge is easily interfered by the noise from the power or signal source, thus causing the latch up problem.

(2) Since the matching circuit is added extra into the conventional protection circuit scheme for electrostatic discharge, it causes a waste of space inside the integrated circuit and the silicon area in the integrated circuit.

### SUMMARY OF THE INVENTION

Therefore, the present invention provides a protection circuit scheme for electrostatic discharge. An isolated circuit in the protection circuit scheme for electrostatic discharge is used to avoid the latch up problem of the electrostatic discharge clamp circuit, and to avoid the damage of the electrostatic discharge clamp circuit due to the direct bias flooding from the internal circuit.

Therefore, the present invention provides a protection circuit scheme for electrostatic discharge. The electrostatic discharge clamp circuit in the protection circuit scheme for electrostatic discharge is used to sustain a high energy electrostatic voltage and reduce its matching level with respect to the signal input.

The present invention provides a protection circuit scheme for electrostatic discharge. The protection circuit comprises an isolated circuit and an electrostatic discharge clamp circuit. The protection circuit scheme for electrostatic discharge electrically couples to a signal input, an internal circuit, a voltage source, and a ground terminal. The power clamp circuit and the internal circuit are also electrically coupled to the ground terminal and the voltage source.

The electrostatic discharge clamp circuit electrically coupled to the signal input mentioned above receives the electrostatic voltage from the signal input, so as to prevent the internal circuit from being damaged by the electrostatic voltage. The electrostatic discharge clamp circuit has an extreme low sustain voltage and is also capable of enduring high current density when its electrostatic voltage is discharged, and also has low parasitic resistance characteristic when it is normally operated. Further, the electrostatic discharge clamp circuit is able to sustain a high energy electrostatic voltage and reduce its matching level with respect to the signal input. The electrostatic discharge clamp circuit comprises a joining point and a clamp unit, wherein the joining point is electrically coupled to the signal input and the isolated circuit, and the clamp unit is electrically coupled to the joining point.

The isolated circuit electrically coupled to the signal input and the internal circuit mentioned above receives a high frequency signal sent from the signal input and outputs it to the internal circuit. The isolated circuit also isolates the direct bias from the internal circuit, and allows the sustain voltage of the electrostatic discharge clamp circuit to be a low sustain voltage. The isolated circuit further comprises the fact that the high frequency signal can pass through the isolated circuit in the case when the internal circuit is normally operated.

In accordance with the preferred embodiment of the present invention, the protection circuit scheme for electrostatic discharge is suitable for use in the wireless circuit module or in the hybrid module circuit.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 shows a circuit block diagram of a conventional protection circuit scheme for electrostatic discharge;

FIG. 2 schematically shows a circuit block diagram of another conventional protection circuit scheme for electrostatic discharge;

FIG. 3 schematically shows a circuit block diagram of a protection circuit scheme for electrostatic discharge of a preferred embodiment according to the present invention;

FIG. 4 schematically shows a circuit block diagram of another protection circuit scheme for electrostatic discharge of the preferred embodiment according to the present invention;

FIG. 5 schematically shows a voltage vs. current diagram with respect to the electrostatic discharge clamp circuit of the protection circuit scheme for electrostatic discharge of the preferred embodiment according to the present invention;

FIG. 6A schematically shows a structure diagram of a clamp unit in the protection circuit scheme for electrostatic discharge of the preferred embodiment according to the present invention; and

FIG. 6B schematically shows a structure diagram of the other clamp unit in the protection circuit scheme for electrostatic discharge of the preferred embodiment according to the present invention.

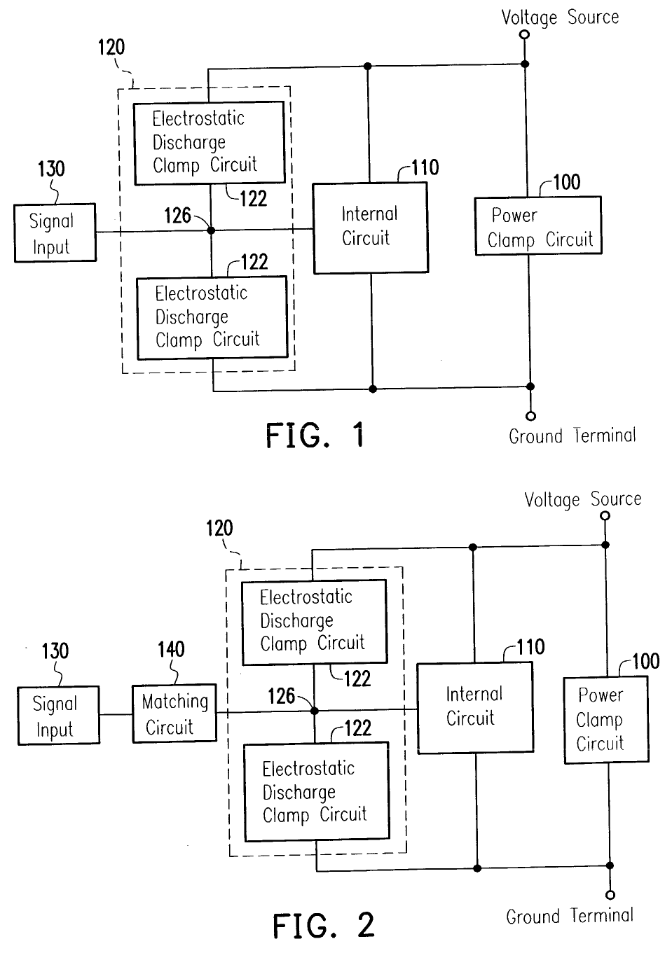

### DESCRIPTION OF THE PREFERRED EMBODIMENTS

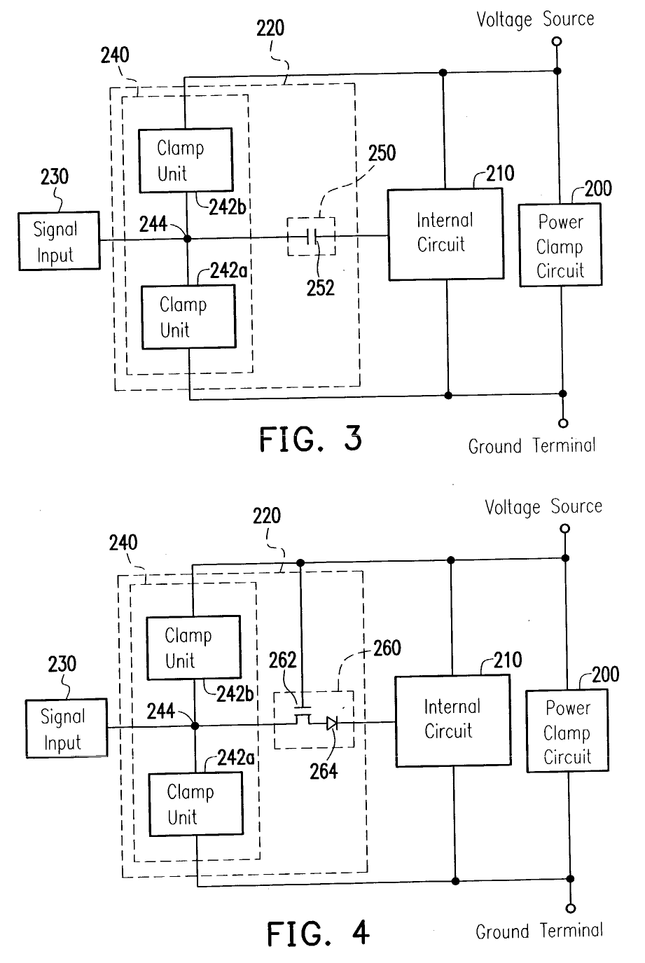

FIG. 3 schematically shows a circuit block diagram of a protection circuit scheme for electrostatic discharge of a preferred embodiment according to the present invention. The protection circuit scheme for electrostatic discharge 220 is suitable for use in the wireless circuit module or in the hybrid module circuit, so as to eliminate the defect in the prior art. The protection circuit scheme for electrostatic discharge 220 comprises an electrostatic discharge clamp circuit 240 and an isolated circuit 250, and the protection circuit scheme for electrostatic discharge 220 electrically couples to a signal input 230 and an internal circuit 210. Further, the internal circuit 210, the protection circuit scheme for electrostatic discharge 220, and the signal input 230 are all electrically coupled to a voltage source and a ground terminal. There is also a power clamp circuit 200 configured between the voltage source and the ground terminal, so as to protect the circuit module.

In the protection circuit scheme for electrostatic discharge 220, the electrostatic discharge clamp circuit 240 is electrically coupled to the signal input 230 for receiving the electrostatic voltage sent from the signal input 230. The electrostatic discharge clamp circuit 240 has an extreme low sustain voltage and is also capable of enduring high current density when its electrostatic voltage is discharged, and also has low parasitic resistance characteristic when it is normally operated. Further, the electrostatic discharge clamp circuit 240 can sustain a high energy electrostatic voltage, e.g. 1000 V. The electrostatic discharge clamp circuit 240 further comprises two clamp units 242a and 242b, wherein both the clamp unit 242a and the clamp unit 242b are electrically coupled to a joining point 244, and the joining point 244 is also electrically coupled to the signal input 230.

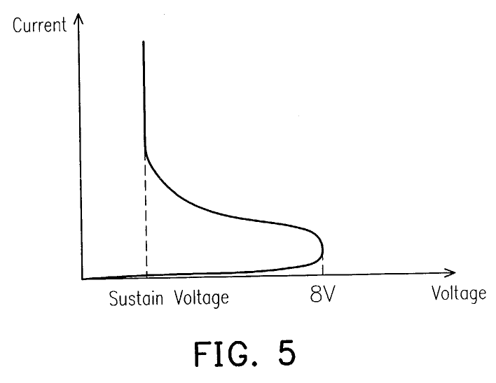

The clamp unit 242a and the clamp unit 242b are the Silicon Controlled Rectifier (SCR), wherein the SCR may be a Modified Lateral SCR (MLSCR) or a Low Voltage Trigger Silicon Controlled Rectifier (LVTSCR). Thanks to the small size of the SCR, its parasitic capacitor is small, thus it is able to support low load. Further, since the SCR has a low sustain voltage, it can generate low power. Therefore, it has a better performance. FIG. 5 schematically shows a voltage vs. current diagram with respect to the electrostatic discharge clamp circuit of the protection circuit scheme for electrostatic discharge of the preferred embodiment according to the present invention. In order to have the clamp unit 242a and 242b provide better performance, the voltage is kept as constant after it reaches a low sustain voltage.

In the electrostatic discharge clamp circuit 220, the isolated circuit 250 is electrically coupled to the signal input 230 and the internal circuit 210. The isolated circuit 250 receives the high frequency signal sent from the signal input 230, and outputs it to the internal circuit 210. The high frequency signal is, for example, a signal greater than 500 MHz, but it is not limited by it. The isolated circuit 250 not only isolates the direct bias from the internal circuit 210, but also allows the sustain voltage of the electrostatic discharge clamp circuit 240 to be a low sustain voltage. Furthermore, the isolated circuit allows the high frequency signal to pass through it when the internal circuit 210 is normally operated.

The isolated circuit 250 comprises a capacitor 252, and as known by one skilled in the art the capacitor 252 may be a capacitor made of a metal-metal material, a capacitor made of a polysilicon-polysilicon material, or a capacitor made of a Metal Oxide Semiconductor (MOS), but it is not limited by it.

Referring to FIG. 4, it schematically shows a circuit block diagram of the other protection circuit scheme for electrostatic discharge of the preferred embodiment according to the present invention. The difference is that the isolated circuit 260 in FIG. 4 comprises a switching element 262 and a uni-directional conductive element 264 when it is compared with FIG. 3. The switching element 262 makes the high frequency signal sent from the signal input 230 pass through it, and outputs the high frequency signal to the internal circuit 210 via the uni-directional conductive element 264. The uni-directional conductive element 264 isolates the direct bias from the internal circuit 210, so as to achieve the same function provided by the capacitor 252 in FIG. 3. The uni-directional conductive element 264 may be a Schottky diode, and the switching element 262 may be a transistor, but it is not limited by it.

In the preferred embodiment of the present invention, the isolated circuit 260 may be a diode (not shown), but it is not limited by it.

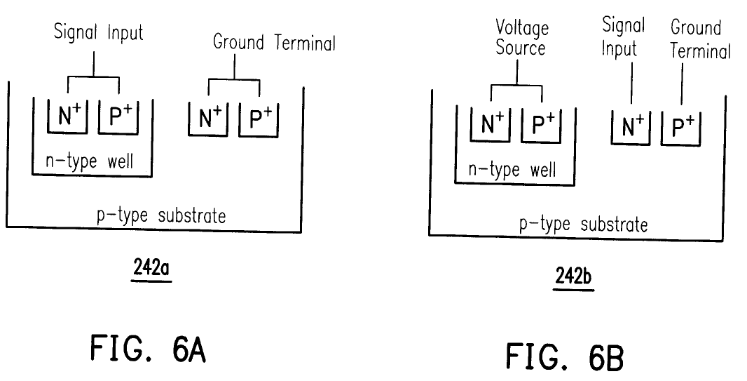

Referring to both FIG. 6A and FIG. 6B, it schematically shows a structure diagram of a clamp unit in the protection circuit scheme for electrostatic discharge of the preferred embodiment according to the present invention, respectively. In FIG. 6A, the clamp unit 242a is a p-type substrate. The p-type substrate comprises an n-type well, a pole n+, and a pole p+. The n-type well comprises a pole n+ and a pole p+, wherein the pole n+ and the pole p+are all electrically grounded, and the pole n+ and the pole p+in the n-type well are electrically coupled to the signal input. In FIG. 6B, the clamp unit 242b is a p-type substrate. The p-type substrate comprises an n-type well, a pole n+, and a pole p+. The n-type well comprises a pole n+ and a pole p+, wherein the pole n+is electrically coupled to the signal input, and the pole p+is electrically grounded. The pole n+ and the pole p+in the n-type well are electrically coupled to the voltage source.

In summary, the protection circuit scheme for electrostatic discharge of the present invention has the following advantages:

(1) In the protection circuit scheme for electrostatic discharge of the present invention, the electrostatic discharge clamp circuit makes the signal pulse input into the internal circuit to be a high frequency signal that can be accepted by the internal circuit.

(2) In the protection circuit scheme for electrostatic discharge of the present invention, the isolated circuit can isolate the direct bias from the internal circuit.

(3) In the protection circuit scheme for electrostatic discharge of the present invention, by integrating an electrostatic discharge clamp circuit and the isolated circuit, the high trigger voltage, low trigger time, and loss of latch up problems that happened in the protection circuit scheme for electrostatic discharge can be eliminated.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A protection circuit scheme for electrostatic discharge, suitable for use in between a signal input and an internal circuit, comprising:
an electrostatic discharge clamp circuit, wherein the electrostatic discharge clamp circuit is electrically coupled to the signal input for receiving an electrostatic voltage sent from the signal input; and
an isolated circuit, wherein the isolated circuit is electrically coupled to the electrostatic discharge clamp circuit, the signal input, and the internal circuit, so as to receive a high frequency signal sent from the signal input, and to output the high frequency signal to the internal circuit, wherein the isolated circuit also isolates a direct bias from the internal circuit.

2. The protection circuit scheme for electrostatic discharge of claim 1, wherein the electrostatic discharge clamp circuit further comprises the fact of having an extreme low sustain voltage and a capability of enduring a high current density when its electrostatic voltage is discharged, and having a parasitic resistance characteristic when it is normally operated.

3. The protection circuit scheme for electrostatic discharge of claim 1, suitable for use in a wireless circuit module.

4. The protection circuit scheme for electrostatic discharge of claim 1, suitable for use in a hybrid module circuit.

5. The protection circuit scheme for electrostatic discharge of claim 1, wherein the electrostatic discharge clamp circuit comprises:
a joining point, wherein the joining point is electrically coupled to the signal input and the isolated circuit; and
a clamp unit, wherein the clamp unit is electrically coupled to the joining point.

6. The protection circuit scheme for electrostatic discharge of claim 5, wherein the clamp unit comprises a Silicon Controlled Rectifier (SCR).

7. The protection circuit scheme for electrostatic discharge of claim 6, wherein the SCR comprises a Modified Lateral SCR (MLSCR).

8. The protection circuit scheme for electrostatic discharge of claim 6, wherein the SCR comprises a Low Voltage Trigger Silicon Controlled Rectifier (LVTSCR).

9. The protection circuit scheme for electrostatic discharge of claim 1, wherein the isolated circuit comprises a capacitor.

10. The protection circuit scheme for electrostatic discharge of claim 9, wherein the capacitor is made of a metal-metal material.

11. The protection circuit scheme for electrostatic discharge of claim 9, wherein the capacitor is made of a polysilicon-polysilicon material.

12. The protection circuit scheme for electrostatic discharge of claim 9, wherein the capacitor comprises a Metal Oxide Semiconductor (MOS) capacitor.

13. The protection circuit scheme for electrostatic discharge of claim 1, wherein the isolated circuit comprises a switching element and a uni-directional conductive element.

14. The protection circuit scheme for electrostatic discharge of claim 13, wherein the switching element comprising a transistor.

15. The protection circuit scheme for electrostatic discharge of claim 13, wherein the uni-directional conductive element comprises a Schottky diode.

16. The protection circuit scheme for electrostatic discharge of claim 1, wherein the isolated circuit comprises a diode.
